(19) United States
(12) Patent Application Publication
(10) Pub. No.: US 2021/0133680 A1
(43) Pub. Date: May 6, 2021

(54) USER PORTAL FOR ROBOTIC PROCESS AUTOMATION BACKGROUND

(71) Applicant: UiPath, Inc., New York, NY (US)

(72) Inventors: Liji Kunnath, Bangalore (IN); Palak Kadakia, Redmond, WA (US)

(73) Assignee: UiPath, Inc., New York, NY (US)

(21) Appl. No.: 16/715,074

(22) Filed: Dec. 16, 2019

(30) Foreign Application Priority Data
Oct. 31, 2019 (IN) 201911044226

(51) Int. Cl. G06Q 10/10; G06F 9/455; G06F 16/93; G06F 16/904

(52) U.S. Cl. CPC G06Q 10/10; G06F 16/904; G06F 16/93; G06F 9/45512

(57) ABSTRACT

A portal is provided to allow a user to input information to a form or to allow the user to upload a document. The information associated with the form or uploaded document is stored in a queue. The stored information is read by an unattended robot and the unattended robot gathers related information from other systems. The gathered related information is provided by the unattended robot to be validated and/or corrected. The validated and/or corrected data is received and a task is performed by the unattended robot using the validated and/or corrected data. The unattended robot updates a business system based on the performed task.

### BACKGROUND

The automation of business processes and procedures is rapidly occurring. Processes that were conventionally done by a person through user input to a computing system are now being performed by software robots using robotic processing automation (RPA). One approach to RPA is to have business users provide information to potentially be performed by a robot and an administrator user can control the robots to perform tasks associated with the information, such as completing a purchase order. However, additional automation can be achieved if the bots can performs tasks in response to business users information with less oversight by an administrator/administrator user.

Accordingly, it is desirable to have a more efficient manner for a user to interact with robots.

### SUMMARY

A portal is provided to allow a user to input information to a form or to allow the user to upload a document. The information associated with the form or uploaded document is stored in a queue. The stored information is read by an unattended robot and the unattended robot gathers related information from other systems. The gathered related information is provided by the unattended robot to be validated and/or corrected. The validated and/or corrected data is received and a task is performed by the unattended robot using the validated and/or corrected data. The unattended robot updates a business system based on the performed task.

### BRIEF DESCRIPTION OF THE DRAWING(S)

A more detailed understanding may be had from the following description, given by way of example in conjunction with the accompanying drawings, wherein like reference numerals in the figures indicate like elements, and wherein:

FIG. 1A is an illustration of robotic process automation (RPA) development, design, operation, or execution;

FIG. 1B is another illustration of RPA development, design, operation, or execution;

FIG. 1C is an illustration of a computing system or environment;

FIG. 2 is a simplified illustration of an example of a user portal RPA system;

FIG. 3 is a flow diagram of form processing using user portal RPA; and

FIG. 4 is a flow diagram of a file upload using user portal RPA.

### DETAILED DESCRIPTION

For the methods and processes described below the steps recited may be performed out of sequence in any order and sub-steps not explicitly described or shown may be performed. In addition, “coupled” or “operatively coupled” may mean that objects are linked but may have zero or more intermediate objects between the linked objects. Also, any combination of the disclosed features/elements may be used in one or more embodiments. When using referring to “A or B”, it may include A, B, or A and B, which may be extended similarly to longer lists. When using the notation X/Y it may include X or Y. Alternatively, when using the notation X/Y it may include X and Y. X/Y notation may be extended similarly to longer lists with the same explained logic.

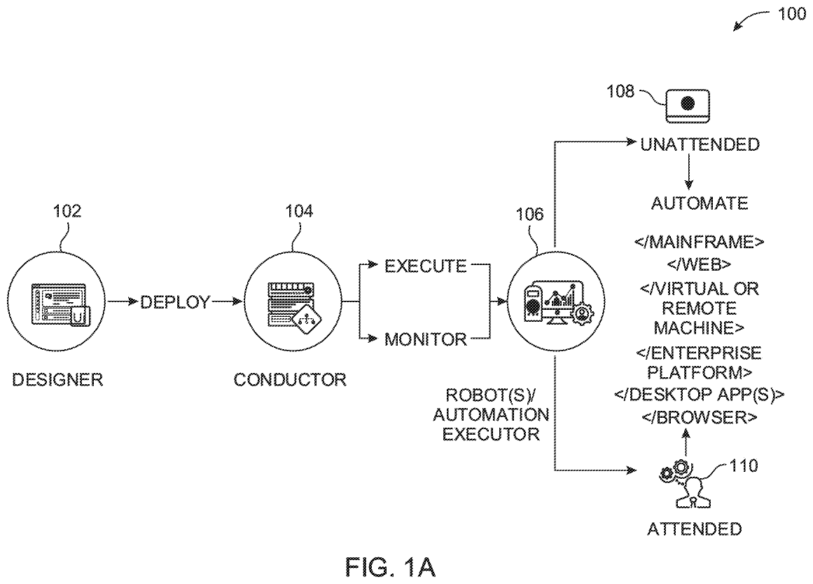

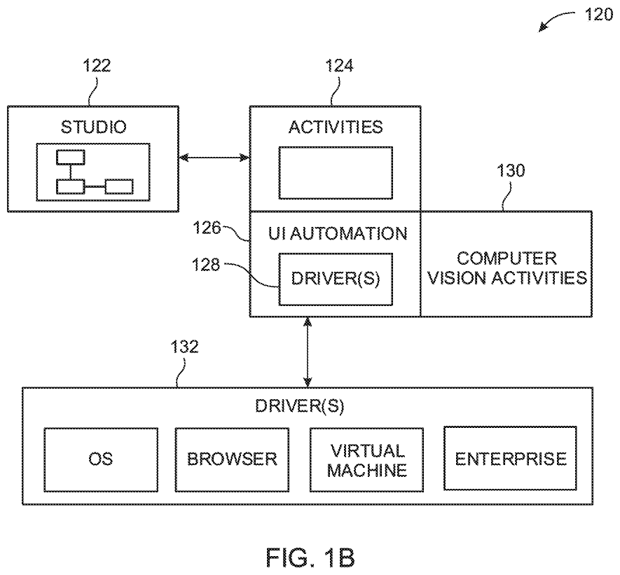

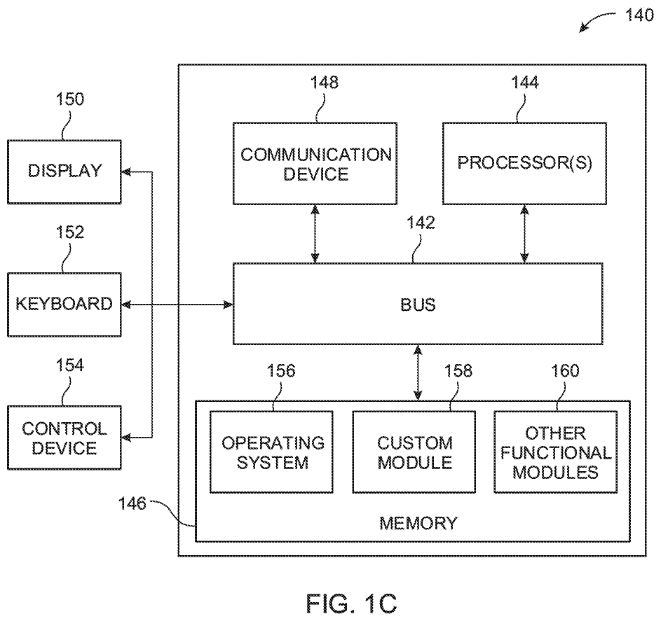

FIG. 1A is an illustration of robotic process automation (RPA) development, design, operation, or execution 100. Designer 102, sometimes referenced as a studio, development platform, development environment, or the like may be configured to generate code, instructions, commands, or the like for a robot to perform or automate one or more workflows. From a selection(s), which the computing system may provide to the robot, the robot may determine representative data of the area(s) of the visual display selected by a user or operator. As part of RPA, shapes such as squares, rectangles, circles, polygons, freeform, or the like in multiple dimensions may be utilized for UI robot development and runtime in relation to a computer vision (CV) operation or machine learning (ML) model.

Non-limiting examples of operations that may be accomplished by a workflow may be one or more of performing login, filling a form, information technology (IT) management, or the like. To run a workflow for UI automation, a robot may need to uniquely identify specific screen elements, such as buttons, checkboxes, text fields, labels, etc., regardless of application access or application development. Examples of application access may be local, virtual, remote, cloud, Citrix®, VMWare®, VNC®, Windows® remote desktop, virtual desktop infrastructure (VDI), or the like. Examples of application development may be win32, Java, Flash, hypertext markup language ((HTML), HTML5, extensible markup language (XML), Javascript, C#, C++, Silverlight, or the like.

A workflow may include, but are not limited to, task sequences, flowcharts, Finite State Machines (FSMs), global exception handlers, or the like. Task sequences may be linear processes for handling linear tasks between one or more applications or windows. Flowcharts may be configured to handle complex business logic, enabling integration of decisions and connection of activities in a more diverse manner through multiple branching logic operators. FSMs may be configured for large workflows. FSMs may use a finite number of states in their execution, which may be triggered by a condition, transition, activity, or the like. Global exception handlers may be configured to determine workflow behavior when encountering an execution error, for debugging processes, or the like.

A robot may be an application, applet, script, or the like, that may automate a UI transparent to an underlying operating system (OS) or hardware. At deployment, one or more robots may be managed, controlled, or the like by a conductor 104, sometimes referred to as an orchestrator. Conductor 104 may instruct or command robot(s) or automation executor 106 to execute or monitor a workflow in a mainframe, web, virtual machine, remote machine, virtual desktop, enterprise platform, desktop app(s), browser, or the like client, application, or program. Conductor 104 may act as a central or semi-central point to instruct or command a plurality of robots to automate a computing platform.

In certain configurations, conductor 104 may be configured for provisioning, deployment, configuration, queueing, monitoring, logging, and/or providing interconnectivity. Provisioning may include creating and maintenance of connections or communication between robot(s) or automation executor 106 and conductor 104. Deployment may include assuring the delivery of package versions to assigned robots for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 104 may provide interconnectivity by acting as the centralized point of communication for third-party solutions and/or applications.

Robot(s) or automation executor 106 may be configured as unattended 108 or attended 110. For unattended 108 operations, automation may be performed without third party inputs or control. For attended 110 operation, automation may be performed by receiving input, commands, instructions, guidance, or the like from a third party component.

A robot(s) or automation executor 106 may be execution agents that run workflows built in designer 102. A commercial example of a robot(s) for UI or software automation is UiPath Robots™. In some embodiments, robot(s) or automation executor 106 may install the Microsoft Windows® Service Control Manager (SCM)-managed service by default. As a result, such robots can open interactive Windows® sessions under the local system account, and have the rights of a Windows® service.

In some embodiments, robot(s) or automation executor 106 may be installed in a user mode. These robots may have the same rights as the user under which a given robot is installed. This feature may also be available for High Density (HD) robots, which ensure full utilization of each machine at maximum performance such as in an HD environment.

In certain configurations, robot(s) or automation executor 106 may be split, distributed, or the like into several components, each being dedicated to a particular automation task or activity. Robot components may include SCM-managed robot services, user mode robot services, executors, agents, command line, or the like. SCM-managed robot services may manage or monitor Windows® sessions and act as a proxy between conductor 104 and the execution hosts (i.e., the computing systems on which robot(s) or automation executor 106 is executed). These services may be trusted with and manage the credentials for robot(s) or automation executor 106.

User mode robot services may manage and monitor Windows® sessions and act as a proxy between conductor 104 and the execution hosts. User mode robot services may be trusted with and manage the credentials for robots 130. A Windows® application may automatically be launched if the SCM-managed robot service is not installed.

Executors may run given jobs under a Windows® session (i.e., they may execute workflows). Executors may be aware of per-monitor dots per inch (DPI) settings. Agents may be Windows® Presentation Foundation (WPF) applications that display available jobs in the system tray window. Agents may be a client of the service. Agents may request to start or stop jobs and change settings. The command line may be a client of the service. The command line is a console application that can request to start jobs and waits for their output.

In configurations where components of robot(s) or automation executor 106 are split as explained above helps developers, support users, and computing systems more easily run, identify, and track execution by each component. Special behaviors may be configured per component this way, such as setting up different firewall rules for the executor and the service. An executor may be aware of DPI settings per monitor in some embodiments. As a result, workflows may be executed at any DPI, regardless of the configuration of the computing system on which they were created. Projects from designer 102 may also be independent of browser zoom level. For applications that are DPI-unaware or intentionally marked as unaware, DPI may be disabled in some embodiments.

FIG. 1B is another illustration of RPA development, design, operation, or execution 120. A studio component or module 122 may be configured to generate code, instructions, commands, or the like for a robot to perform one or more activities 124. User interface (UI) automation 126 may be performed by a robot on a client using one or more driver(s) components 128. A robot may perform activities using computer vision (CV) activities module or engine 130. Other drivers 132 may be utilized for UI automation by a robot to get elements of a UI. They may include OS drivers, browser drivers, virtual machine drivers, enterprise drivers, or the like. In certain configurations, CV activities module or engine 130 may be a driver used for UI automation.

FIG. 1C is an illustration of a computing system or environment 140 that may include a bus 142 or other communication mechanism for communicating information or data, and one or more processor(s) 144 coupled to bus 142 for processing. One or more processor(s) 144 may be any type of general or specific purpose processor, including a central processing unit (CPU), application specific integrated circuit (ASIC), field programmable gate array (FPGA), graphics processing unit (GPU), controller, multi-core processing unit, three dimensional processor, quantum computing device, or any combination thereof. One or more processor(s) 144 may also have multiple processing cores, and at least some of the cores may be configured to perform specific functions. Multi-parallel processing may also be configured. In addition, at least one or more processor(s) 144 may be a neuromorphic circuit that includes processing elements that mimic biological neurons.

Memory 146 may be configured to store information, instructions, commands, or data to be executed or processed by processor(s) 144. Memory 146 can be comprised of any combination of random access memory (RAM), read only memory (ROM), flash memory, solid-state memory, cache, static storage such as a magnetic or optical disk, or any other types of non-transitory computer-readable media or combinations thereof. Non-transitory computer-readable media may be any media that can be accessed by processor(s) 144 and may include volatile media, non-volatile media, or the like. The media may also be removable, non-removable, or the like.

Communication device 148, may be configured as a frequency division multiple access (FDMA), single carrier FDMA (SC-FDMA), time division multiple access (TDMA), code division multiple access (CDMA), orthogonal frequency-division multiplexing (OFDM), orthogonal frequency-division multiple access (OFDMA), Global System for Mobile (GSM) communications, general packet radio service (GPRS), universal mobile telecommunications system (UMTS), cdma2000, wideband CDMA (W-CDMA), high-speed downlink packet access (HSDPA), high-speed uplink packet access (HSUPA), high-speed packet access (HSPA), long term evolution (LTE), LTE Advanced (LTE-A), 802.11x, Wi-Fi, Zigbee, Ultra-WideBand (UWB), 802.16x, 802.15, home Node-B (HnB), Bluetooth, radio frequency identification (RFID), infrared data association (IrDA), near-field communications (NFC), fifth generation (5G), new radio (NR), or any other wireless or wired device/transceiver for communication via one or more antennas. Antennas may be singular, arrayed, phased, switched, beamforming, beamsteering, or the like.

One or more processor(s) 144 may be further coupled via bus 142 to a display device 150, such as a plasma, liquid crystal display (LCD), light emitting diode (LED), field emission display (FED), organic light emitting diode (OLED), flexible OLED, flexible substrate displays, a projection display, 4K display, high definition (HD) display, a Retina© display, in-plane switching (IPS) or the like based display. Display device 150 may be configured as a touch, three dimensional (3D) touch, multi-input touch, or multi-touch display using resistive, capacitive, surface-acoustic wave (SAW) capacitive, infrared, optical imaging, dispersive signal technology, acoustic pulse recognition, frustrated total internal reflection, or the like as understood by one of ordinary skill in the art for input/output (I/O).

A keyboard 152 and a control device 154, such as a computer mouse, touchpad, or the like, may be further coupled to bus 142 for input to computing system or environment 140. In addition, input may be provided to computing system or environment 140 remotely via another computing system in communication therewith, or computing system or environment 140 may operate autonomously.

Memory 146 may store software components, modules, engines, or the like that provide functionality when executed or processed by one or more processor(s) 144. This may include an OS 156 for computing system or environment 140. Modules may further include a custom module 158 to perform application specific processes or derivatives thereof. Computing system or environment 140 may include one or more additional functional modules 160 that include additional functionality.

Computing system or environment 140 may be adapted or configured to perform as a server, an embedded computing system, a personal computer, a console, a personal digital assistant (PDA), a cell phone, a tablet computing device, a quantum computing device, cloud computing device, a mobile device, a fixed mobile device, a smart display, a wearable computer, or the like.

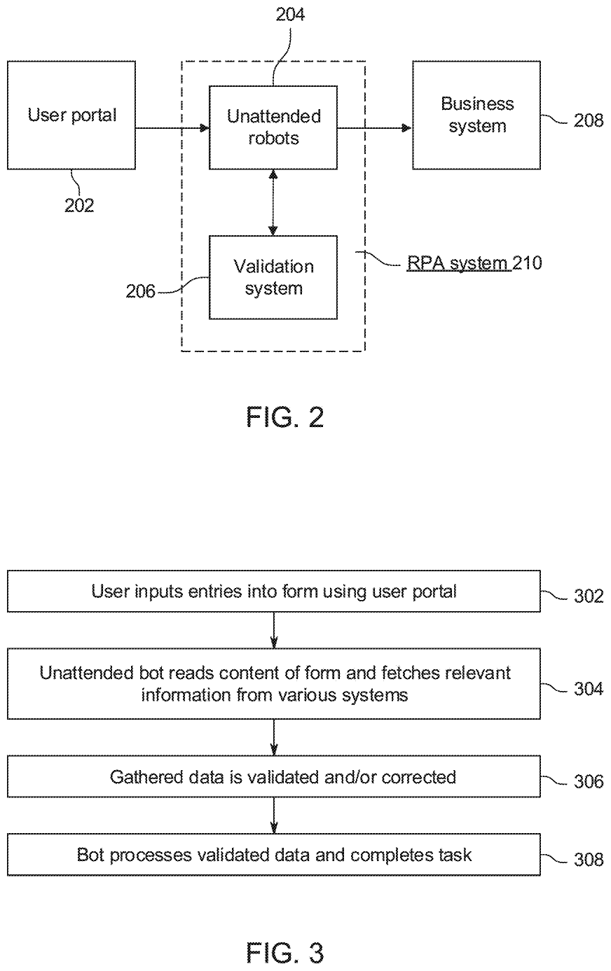

FIG. 2 is a simplified illustration of a user portal RPA system. A business user using a user portal 202 sends information, such as a form or an uploaded file, to an RPA system 210. The information can be loaded into a queue for operation by the RPA 210. The user portal 202 may be a web interface, such as via a browser on a computer, or a mobile interface, such as an application on a mobile device, or other interface. An unattended bot 204 of the RPA 210 processes the information and may additionally fetch/gather additional information needed for processing the information. Optionally, the unattended bot 204 may send information to a validation system 206 to validate that the information that the unattended robot 204 compiled is valid and/or correct the information for further processing by the unattended bot 204. The validation system 206 can be an automated system or involve human validation of the information. The validation system 206 may be the user portal 202, where the business user may validate the information. After completing the processing of the data, the unattended bot 204 updates the business system 208.

This type of system can allow a business user to trigger an unattended process. For example, the unattended process can be triggered based on queue items through the forms or uploaded files. The user can add some data to the queue via the portal 202 that will trigger the robot 204. The unattended robot 204 can read the data from the queue and execute the unattended processes based on the queued data.

FIG. 3 is an illustration of the process using a form through the user portal 202. Using the user portal 202, a user inputs data entries into a form, 302. The form can be a custom built form or a stock form. One example of a type of form would be a purchase order, although others can be used. An example of the user portal 202 used in FIG. 3 is as follows. The portal 202 may allow a business user to choose from a list of business input templates that the user has access. The list can display information, such as “Business Input name” and “Queue Name.” The user portal 202, upon the user selecting “Business Input”>“Add”>select a “business Input” name, generates and presents the user a form based on the queue data. The user enters the relevant business context to the corresponding queue that internally is picked up by a relevant unattended bot 204 as per the bot's process schedule. The source of the job to be performed by the bot 204 may list the username of the user who added the queue item though the business input form.

The form is provided to the unattended bot 204, such as via a queue. The unattended bot 204 reads the contents of the form and fetches relevant information from various systems, 304. The user may be notified with relevant information about the job with an ID, such as “ABC”, of process “XYZ” is active. The relevant information is sent to a validation system 206. The validation system 206 validates and corrects the relevant data gathered by the bot 204, 306. The bot 204 processes the validated data and provides information associated with the completed task to the business system 206, 308. Optionally, the results can be routed back to the workflow where the results could be used to execute the next step in the workflow. One such step could be sending the results to the business system,

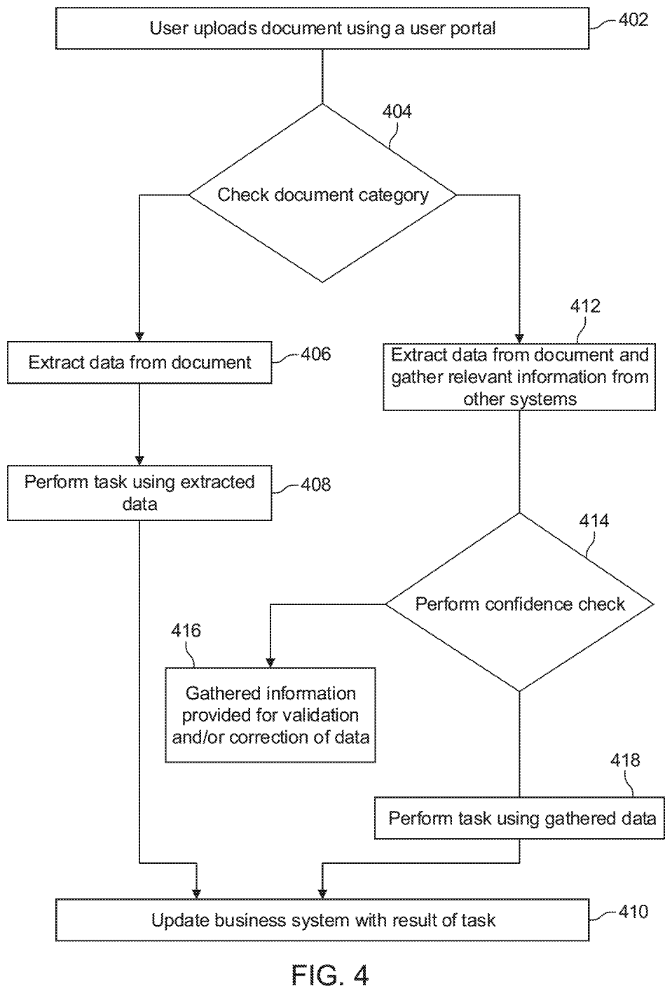

FIG. 4 is an illustration of the process of uploading documents through the user portal 202. Using the user portal 202, a user uploads a document to the RPA, such as to a queue accessible by the RPA, 402. The business user who is entitles to add the document to the RPA may be presented with a document upload screen. Upon selecting “Business Input”>“Add”>select “Business Input name” and as per the configuration set by the admin for the corresponding underlying queue, the document is uploaded to the RPA. The uploaded documents may be converted and added as a string to a queue item. An unattended bot 204 reads contents of the document or queued string. In an embodiment, the bot 204 may check the category of the document for processing, 404. Based on the category of the document, the bot 204 may determine whether a validity check on data is necessary, as certain categories of documents may not require such a task. Alternatively, a category check may not be performed and the branch of FIG. 4 for the validity type review (412, 414, 416, 418) may be perform. Such an embodiment may be more efficient if most document categories require a validity check.

If the category of the document does not require the validation of gathered data, such as for a claim processing, the bot 204 will extract the document information, 406, such as a claim, and gather any relevant information from other systems. The bot 204 then performs an unattended task, 408, such as claim approval. The bot 204 then updates the business system 206 with the result of the task, 410.

If the category of the document may require validation of gathered data, such as for an invoice, the bot 204 extracts the document data, such as invoice date, and gathers any relevant information from other systems, 412. The bot 204 performs a confidence test on the information, 414. If the confidence is high that the information is valid, the bot 204 performs the appropriate task, 418, such as an invoice approval task, and updates the business system 206, 410. If the confidence is low that the information is valid, the information is provided to the validation system 206, which validates and/or corrects the information, 416. The validated information is used to perform an unattended task, 418, and the bot 204 then updates the business system 206 with the result of the task, 410.

The examples above can enable business users to initiate jobs, provide business input to trigger jobs and handle human tasks from a central web instance or mobile interface. Centralized, such as orchestrator, capabilities were available to administrative users previously. These examples potentially allow business users to trigger a process through attended automation, such as a robot tray. For certain categories of business users, the above examples potentially allow them to have the ability to trigger an un-attended process through various input actions (such as adding items to the queue, etc.).

In the examples given herein, modules may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may be at least partially implemented in software for execution by various types of processors. An identified unit of executable code may include one or more physical or logical blocks of computer instructions that may, for instance, be organized as an object, procedure, routine, subroutine, or function. Executables of an identified module co-located or stored in different locations such that, when joined logically together, comprise the module.

A module of executable code may be a single instruction, one or more data structures, one or more data sets, a plurality of instructions, or the like distributed over several different code segments, among different programs, across several memory devices, or the like. Operational or functional data may be identified and illustrated herein within modules, and may be embodied in a suitable form and organized within any suitable type of data structure.

In the examples given herein, a computer program may be configured in hardware, software, or a hybrid implementation. The computer program may be composed of modules that are in operative communication with one another, and to pass information or instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system, comprising:
one or more processors;
a memory coupled to the one or more processors and storing program instructions that when executed by the one or more processors cause the one or more processors to perform:
provide a portal to a user to allow the user to input information to a form or to allow the user to upload a document;
store information associated with the form or uploaded document in a queue;
read the stored information by an unattended robot and gathering related information from other systems;
provide by the unattended robot the gathered related information to be validated and/or corrected;
receive the validated and/or corrected data and perform a task using the validated and/or corrected data; and
update a business system by the unattended robot based on the performed task.

2. The system of claim 1 wherein the one or more processors perform check a category of a form or uploaded file and bypass validation of data of the form or uploaded file based on the checked category.

3. The system of claim 1 wherein the one or more processors performs a confidence check on the gathered data to determine whether validation of gathered data is required.

4. The system of claim 3 wherein the confidence check is performed on the gathered data based on a category of the uploaded file.

5. The system of claim 1 wherein the one or more processors perform send a user an indication that a job is active based on the job being picked up by the unattended robot.

6. The system of claim 1 wherein the user is a business user and not an administrative user.

7. The system of claim 1 wherein the gathered provided information to be validated is sent to the user for validation and/or correction.

8. A method comprising:
providing, by a processor, a portal to a user to allow the user to input information to a form or to allow the user to upload a document;
storing, by a processor, information associated with the form or uploaded document in a queue;
reading, by a processor, the stored information by an unattended robot and gathering related information from other systems;
receiving, by a processor, validated and/or corrected data and performing a task using the validated and/or corrected data; and
updating, by a processor, a business system using the unattended robot based on the performed task.

9. The method of claim 8 further comprising checking, by a processor, a category of a form or uploaded file and bypassing validation of data of the form or uploaded file based on the checked category.

10. The method of claim 8 further comprising performing a confidence check on the gathered data to determine whether validation of gathered data is required.

11. The method of claim 10 wherein the confidence check is performed on the gathered data based on a category of the uploaded file.

12. The method of claim 10 further comprising sending a user an indication that a job is active based on the job being picked up by the unattended robot.

13. The method of claim 8 wherein the user is a business user and not an administrative user.

14. The method of claim 8 wherein the gathered provided information to be validated is sent to the user for validation and/or correction.

15. At least one non-transient computer readable medium containing program instructions for causing at least one computer to perform the method of:
providing a portal to a user to allow the user to input information to a form or to allow the user to upload a document;
storing information associated with the form or uploaded document in a queue;
reading the stored information by an unattended robot and gathering related information from other systems;
receiving validated and/or corrected data and performing a task using the validated and/or corrected data; and
updating a business system using the unattended robot based on the performed task.

16. The at least one computer readable medium of claim 15 further comprising instructions for checking a category of a form or uploaded file and bypassing validation of data of the form or uploaded file based on the checked category.

17. The at least one computer readable medium of claim 15 further comprising instructions for performing a confidence check on the gathered data to determine whether validation of gathered data is required.

18. The at least one computer readable medium of claim 15 wherein the confidence check is performed on the gathered data based on a category of the uploaded file.

19. The at least one computer readable medium of claim 15 further comprising instructions for sending a user an indication that a job is active based on the job being picked up by the unattended robot.

20. The at least one computer readable medium of claim 15 wherein the user is a business user and not an administrative user.
